(19) United States
(12) Patent Application Publication
(10) Pub. No.: US 2008/0019622 A1
(43) Pub. Date: Jan. 24, 2008

(54) Roller holder for motion guide device

(75) Inventor: Tsung Jen Chen, Taichung (TW)

Correspondence Address: CHARLES E. BAXLEY, ESQ., 90 JOHN STREET, THIRD FLOOR, NEW YORK, NY, 10038, US

(73) Assignee: Hiwin Technologies Corp.

(21) Appl. No.: 11/489,072

(22) Filed: Jul. 19, 2006

(51) Int. Cl. F16C 19/00

(52) U.S. Cl. 384/51

(57) ABSTRACT

A roller holder includes an outer holding device having a number of spacers coupled to one or more rods and spaced from each other, the spacers each includes an upper portion located above the rods and a lower portion located below the rods, and each include two or more retainers disposed side by side, and a number of bearing members disposed and retained between the rods and the spacers, and the spacers each include two protrusions extended from each of the retainers for engaging with the bearing members and for decreasing a contact area between the bearing members and the spacers.

### BACKGROUND OF THE INVENTION

1. Field of the Invention

The present invention relates to a roller holder, and more particularly to a roller holder having a number of rollers or bearing members rotatably retained between spacers for engaging between two moving members and for decreasing the contact area between the rollers and the spacers and for facilitating the sliding movement between the two moving members.

2. Description of the Prior Art

Typical screw shafts comprise a screw member threaded into a nut member, or relatively, a nut member threaded onto a screw member, and a number of balls engaged in the threads of the nut member and the screw member for facilitating the rotational and/or sliding movement between the nut member and the screw member. Normally, the balls are simply disposed in the threads of the nut member and the screw member without any ball holders or retaining devices such that the balls may not be stably retained in place to each other.

Typical motion guide devices, such as linear motion guide devices or other motion guide devices also comprise two moving members, such as a track rail and a slider slidably engaged with each other, and a number of balls or rollers engaged between the two moving members for facilitating the sliding movement between the two moving members.

For example, U.S. Pat. No. 6,390,678 to Shirai discloses one of the typical linear motion guide devices comprising a number of rollers engaged between two moving members for increasing the contact between the two moving members and for facilitating the sliding movement between the two moving members. A roller holder device or a connecting member is provided and includes a number of spaces for engaging with the rollers and for rotatably coupling the rollers to the connecting member.

However, the spacers are all in great surface contact with the rollers such that the contact area between the rollers and the spacers is greatly increased and such that the abrasion or scraping between the rollers and the spacers may be increased. In addition, for coupling the rollers to the spacers, an annular groove is required to be machined or formed in each of the rollers for engaging with the protruded connecting members of the spacers, and the rollers may be easily damaged or broken due to the formation of the annular grooves therein and due to stress concentration problems.

U.S. Pat. No. 6,652,146 to Lee discloses another typical linear motion guide device comprising a number of balls engaged between two moving members for facilitating the sliding movement between the two moving members, and a roller holder device also includes a number of spaces for engaging with the rollers and for rotatably coupling the rollers to the roller holder device.

However, the balls are also in great surface contact with the rollers such that the contact area between the rollers and the spacers is greatly increased and such that the abrasion or scraping between the rollers and the spacers may be increased.

The present invention has arisen to mitigate and/or obviate the afore-described disadvantages of the conventional roller holders for the screw shafts or for the linear motion guide devices.

### SUMMARY OF THE INVENTION

The primary objective of the present invention is to provide a roller holder including a number of rollers or bearing members rotatably retained between spacers for engaging between two moving members and for decreasing the contact area between the rollers and the spacers and for facilitating the sliding movement between the two moving members.

In accordance with one aspect of the invention, there is provided a roller holder for engaging between two moving members, the roller holder comprising an outer holding device including a first rod, a number of spacers disposed in the outer holding device and coupled to the first rod and spaced from each other, the spacers each including an upper portion located above the first rod, and a lower portion located below the first rod, and the spacers each including a first retainer and at least one second retainer disposed side by side, and a number of bearing members, such as rollers, disposed in the outer holding device and retained between the first rod and the spacers, and the spacers each include two protrusions extended from each of the first and the second retainers for engaging with the bearing members and for decreasing a contact area between the bearing members and the spacers.

The outer holding device includes a second rod coupled to the spacers, the first and the second rods are parallel to each other and the spacers are disposed between the first and the second rods. The outer holding device includes at least one coupler for coupling each of the spacers to the first rod. The protrusions are preferably curved or cylindrical protrusions.

The protrusions of the first retainer are oppositely extended from the upper portion of the spacers, and the protrusions of the second retainer are oppositely extended from the lower portion of the spacers.

Alternatively, one of the protrusions of the first retainer is extended from the lower portion and the other protrusion of the first retainer is extended from the upper portion of the spacers. Similarly, one of the protrusions of the second retainer is extended from the lower portion of the spacers and the other protrusion of the second retainer is extended from the upper portion of the spacers.

The upper portions and the lower portions of the retainers where no protrusions extended therefrom include an included angle of no less than 90 degrees with the first rod.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a screw shaft or a linear motion guide device having a roller holder in accordance with the present invention engaged therein and engaged between two moving members;

FIG. 2 is a partial cross sectional view taken along lines 2-2 of FIG. 1;

FIG. 3 is another partial cross sectional view of the linear motion guide device;

FIG. 4 is a perspective view illustrating a roller holder for engaging in the linear motion guide device and for engaging between two moving members;

FIG. 5 is an enlarged partial perspective view of the roller holder;

FIGS. 6, 7, 8 are partial cross sectional views taken along lines 6-6, 7-7, 8-8 of FIG. 5 respectively;

FIGS. 9, 10, 11 are partial cross sectional views taken along lines 9-9, 10-10, 11-11 of FIG. 6 respectively;

FIG. 12 is an enlarged partial perspective view similar to FIG. 5, illustrating the other arrangement of the roller holder;

FIGS. 13, 14, 15 are partial cross sectional views taken along lines 13-13, 14-14, 15-15 of FIG. 12 respectively;

FIGS. 16, 17, 18 are partial cross sectional views taken along lines 16-16, 17-17, 18-18 of FIG. 13 respectively;

FIG. 19 is a further enlarged partial perspective view similar to FIGS. 5, 12 illustrating the further arrangement of the roller holder;

FIGS. 20, 21 are partial cross sectional views taken along lines 20-20, 21-21 of FIG. 19 respectively; and

FIGS. 22, 23, 24 are partial cross sectional views taken along lines 22-22, 23-23, 24-24 of FIG. 20 respectively.

### DETAILED DESCRIPTION OF THE PREFERRED EMBODIMENT

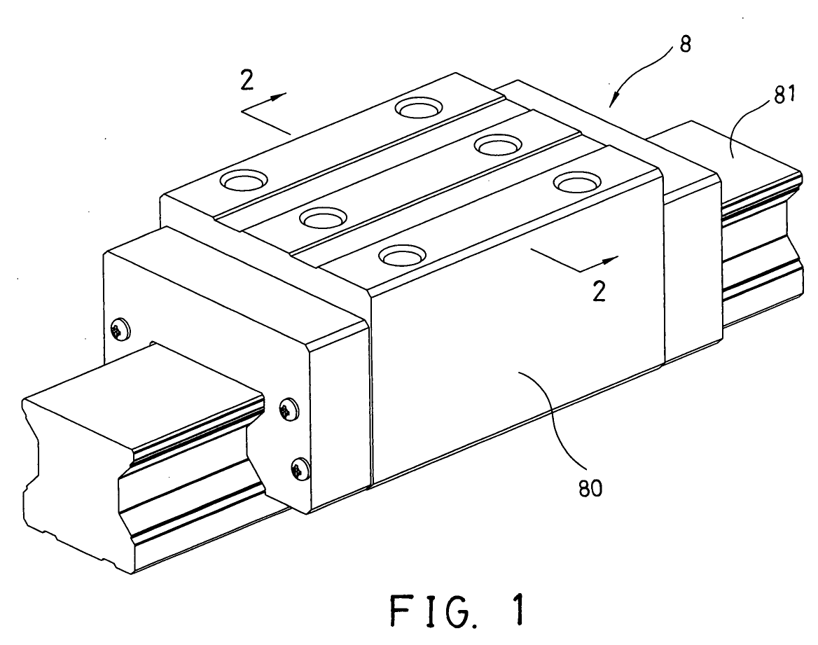

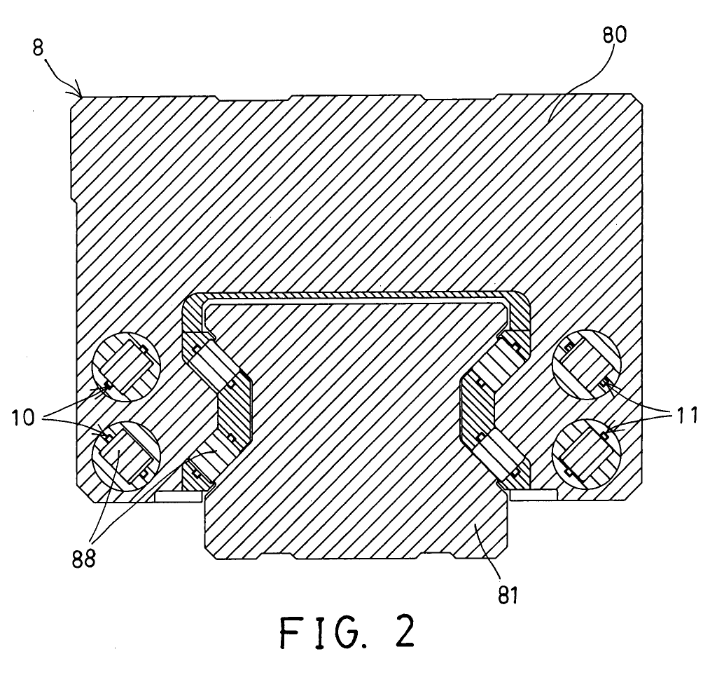

Referring to the drawings, and initially to FIGS. 1-4, a roller holder 10 in accordance with the present invention is provided for being engaged in a screw shaft device or linear motion guide device 8, such as engaged between a slider 80 and a track rail 81 of the linear motion guide device 8, and particularly engaged between the guiding channels of the slider 80 and the track rail 81, for facilitating the sliding movement between the slider 80 and the track rail 81 of the linear motion guide device 8. Similarly, the roller holder 10 in accordance with the present invention may be provided for facilitating the moving or sliding movement between any other two moving members that are moved relative to each other.

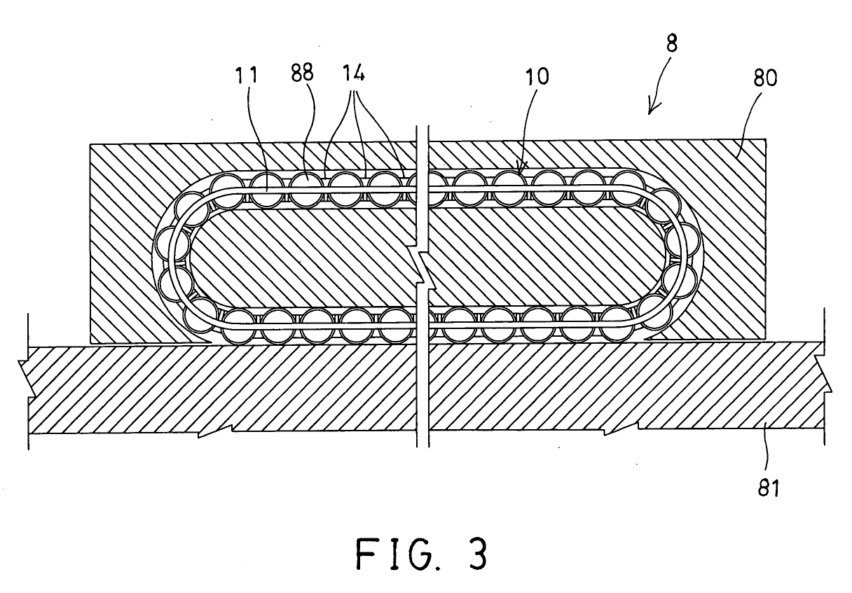

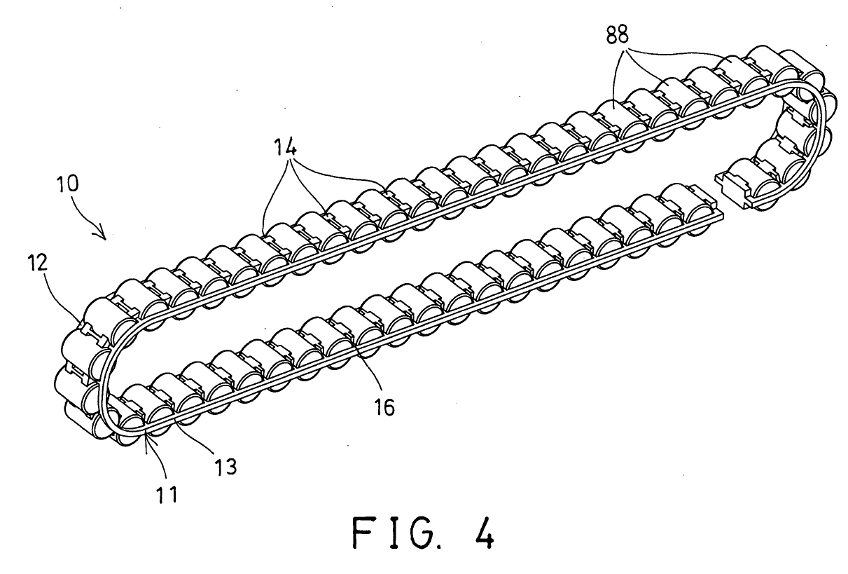

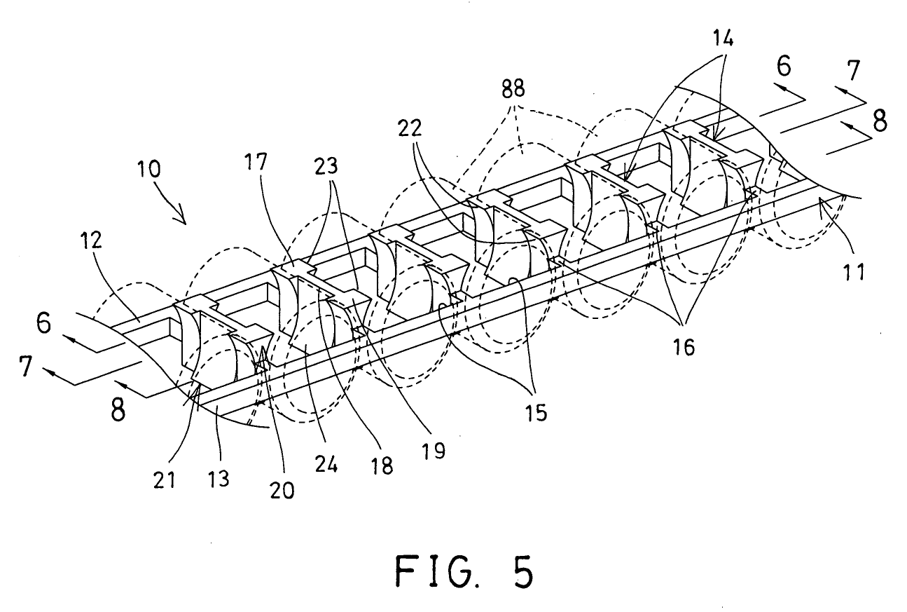

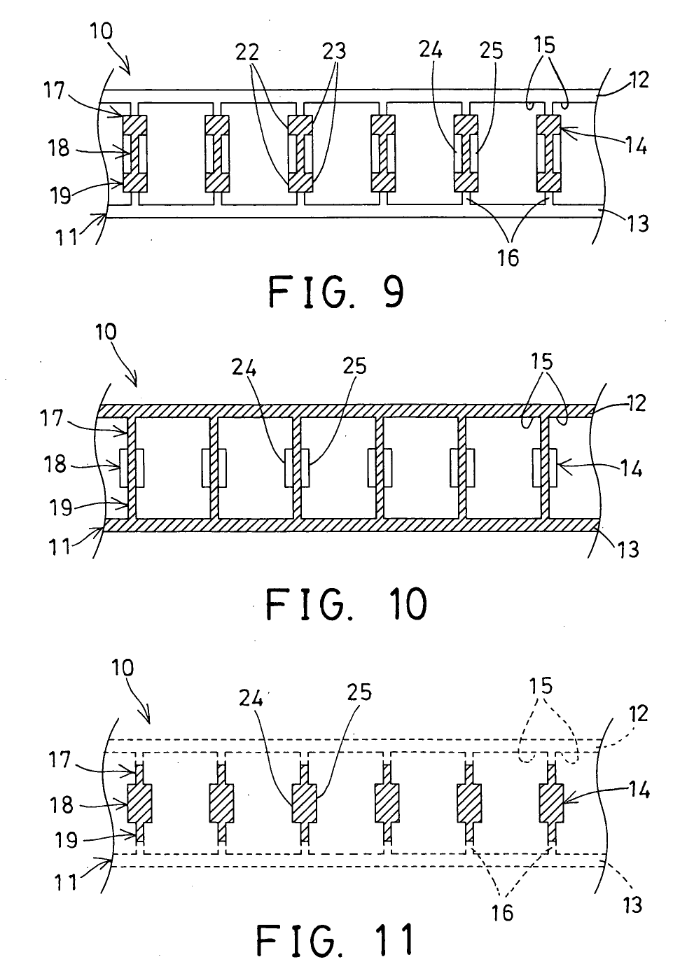

Referring next to FIGS. 3-11, the roller holder 10 in accordance with the present invention comprises an outer holding device 11 including one or more, such as two longitudinal and flexible cables or rods 12, 13 disposed or arranged parallel to each other, and arranged in such as two side portions, and a number of spacers 14 disposed between the rods 12, 13 and equally spaced from each other for forming a number of chambers 15 between the rods 12, 13 and the spacers 14 and for snugly engaging with and for retaining a number of balls or rollers or bearing members 88 between the rods 12, 13 and the spacers 14 (FIGS. 4, 5), and for preventing the bearing members 88 from being disengaged from the rods 12, 13 and the spacers 14 of the outer holding device 11.

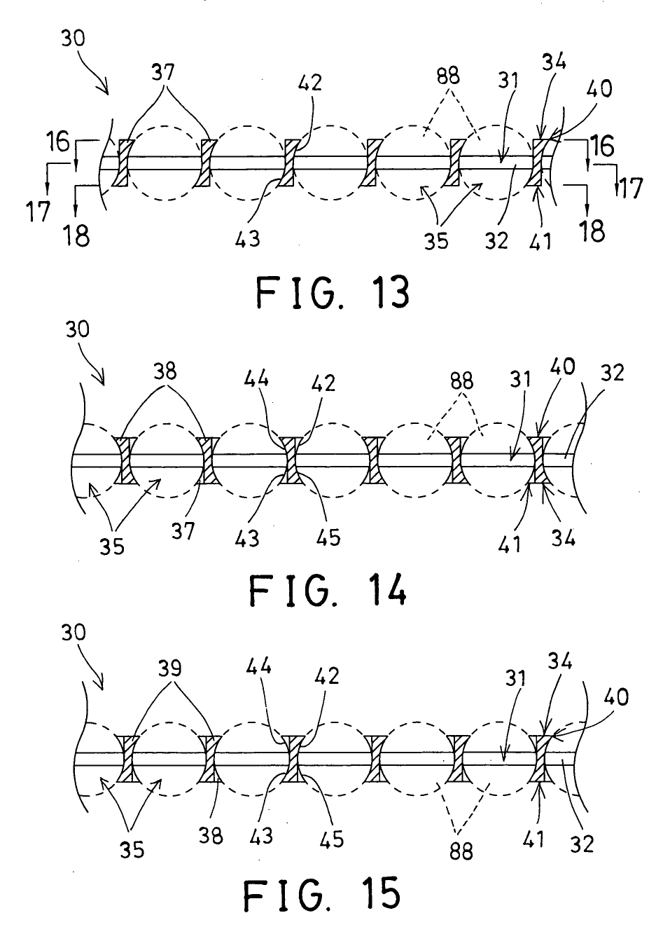

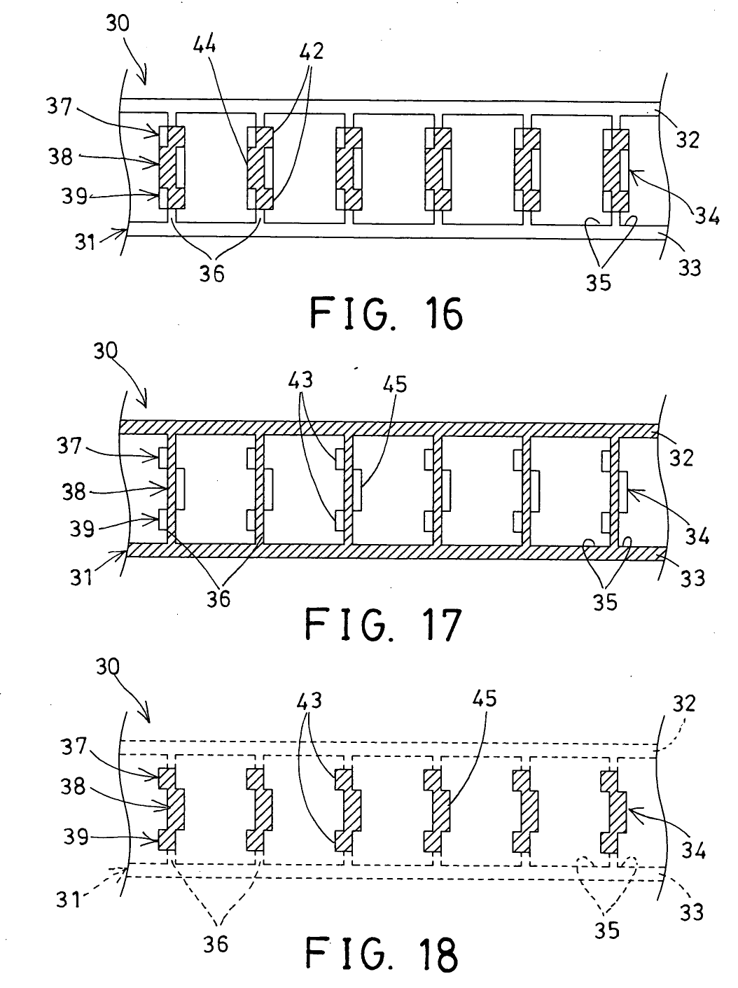

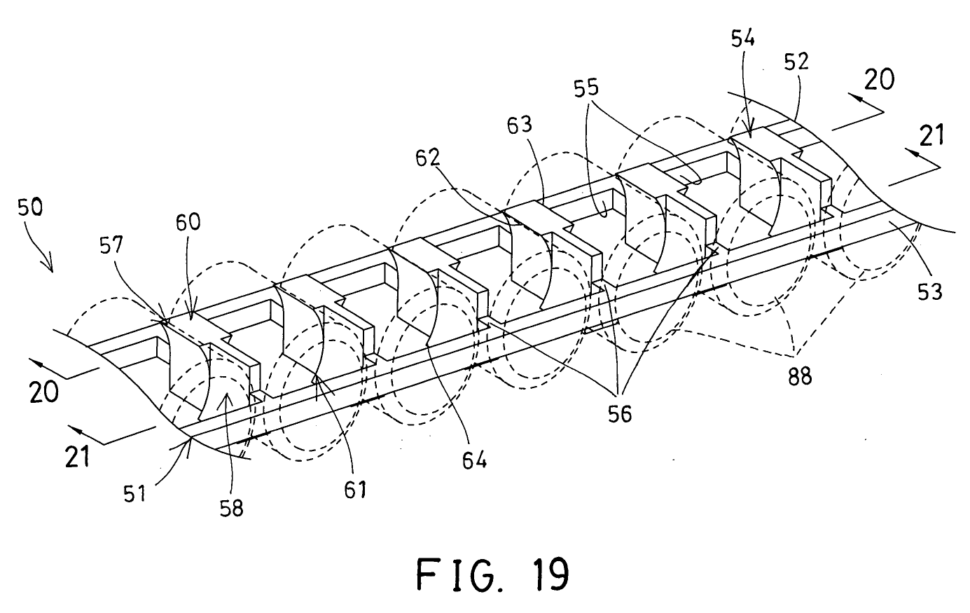

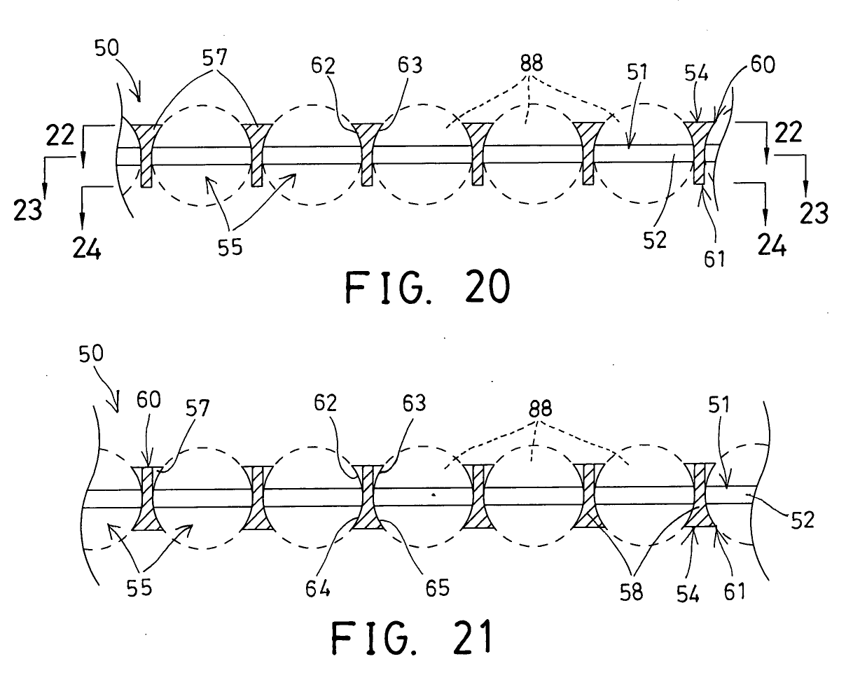

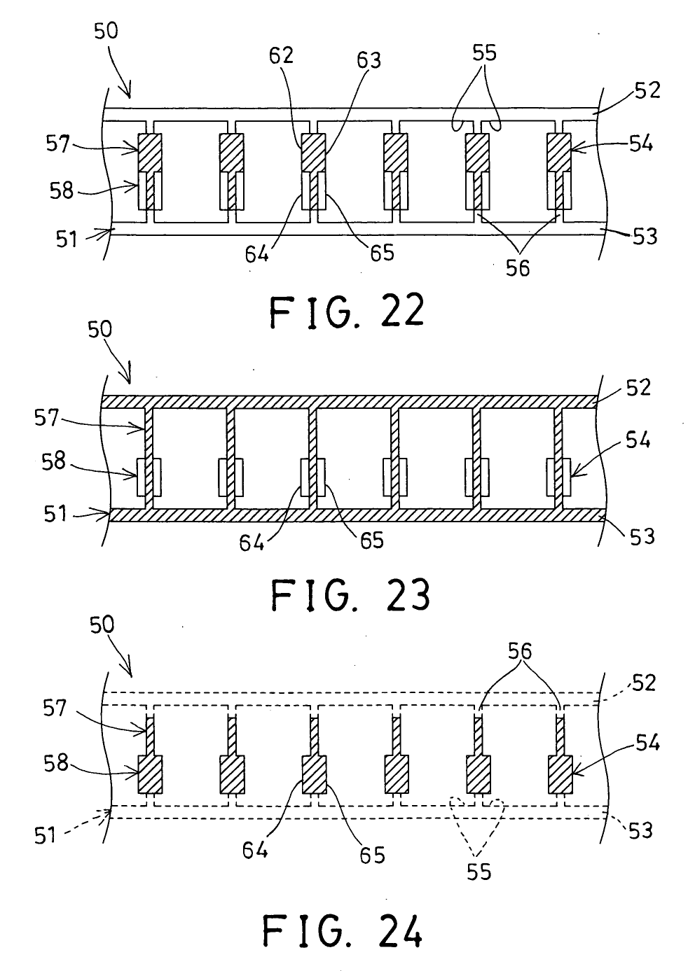

It is preferable that each of the spacers 14 include one or both sides coupled to the rods 12, 13 with a coupler 16 (FIGS. 4, 5), and include a height greater than that of the couplers 16 for resiliently or flexibly coupling the spacers 14 between the rods 12, 13, the couplers 16 may include a height smaller or greater than or equals to that of the rods 12, 13. Each of the spacers 14 include two or more retainers 17, 18, 19 disposed side by side and disposed between the rods 12, 13 and/or the couplers 16. For example, each of the spacers 14 may include two retainers (FIGS. 19-24), three retainers (FIGS. 4-18), or more retainers disposed between the rods 12, 13 and/or the couplers 16. The bearing members 88 are extended out of the spacers 14 of the outer holding device 11 for engaging between the two moving members 80, 81, and for facilitating the sliding movement between the two moving members 80, 81 that will be moved or slid relative to each other.

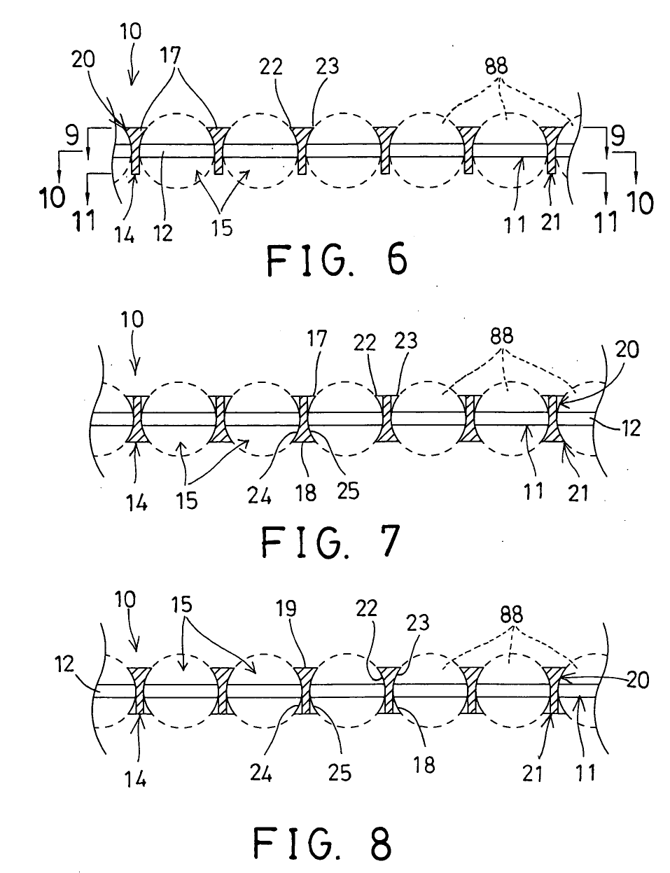

Each of the retainers 17, 18, 19 of the spacers 14 include an upper portion 20 located above or extended upwardly beyond the rods 12, 13 and/or the couplers 16 (FIGS. 5-8), and a lower portion 21 located below or extended downwardly beyond the rods 12, 13 and/or the couplers 16. The retainers 17, 19 each include two protrusions 22, 23, such as curved or cylindrical protrusions 22, 23 oppositely extended from both sides of the upper portion 20 thereof (FIGS. 5, 6) for engaging with the bearing members 88, and the other retainers 18 each include two protrusions 24, 25, such as curved or cylindrical protrusions 24, 25 oppositely extended from both sides of the lower portion 21 thereof (FIGS. 5, 7) for engaging with the bearing members 88.

It is preferable that the lower portion 21 of the retainers 17, 19 and the upper portion 20 of the other retainers 18 where no protrusions extended therefrom are preferably perpendicular to the rods 12, 13 (FIGS. 6-8), or include an included angle of about or greater than or no less than 90 degrees with the rods 12, 13, for allowing the bearing members 88 to be easily engaged with the retainers 17-19. It is further preferable that the protrusions 22-25 of the spacers 14 at one side of each of the bearing members 88 include one protrusion 22, 23 located above the outer holding device 11, and the other protrusion 24, 25 located below the outer holding device 11.

In operation, as shown in FIGS. 5-8, the bearing members 88 may be stably retained in place or retained between the rods 12, 13 and the spacers 14 by the protrusions 22-25 of the retainers 17, 18, 19 of the spacers 14. The retainers 17, 19 each include the protrusions 22, 23 extended from the upper portion 20 thereof for engaging with the bearing members 88, but have no protrusions extended from the lower portion 21 thereof, and the other retainers 18 each include the protrusions 24, 25 extended from the lower portion 21 thereof for engaging with the bearing members 88, but have no protrusions extended from the upper portion 20 thereof, such that the contact area between the bearing members 88 and the protrusions 22-25 of the retainers 17, 18, 19 of the spacers 14 may be greatly reduced.

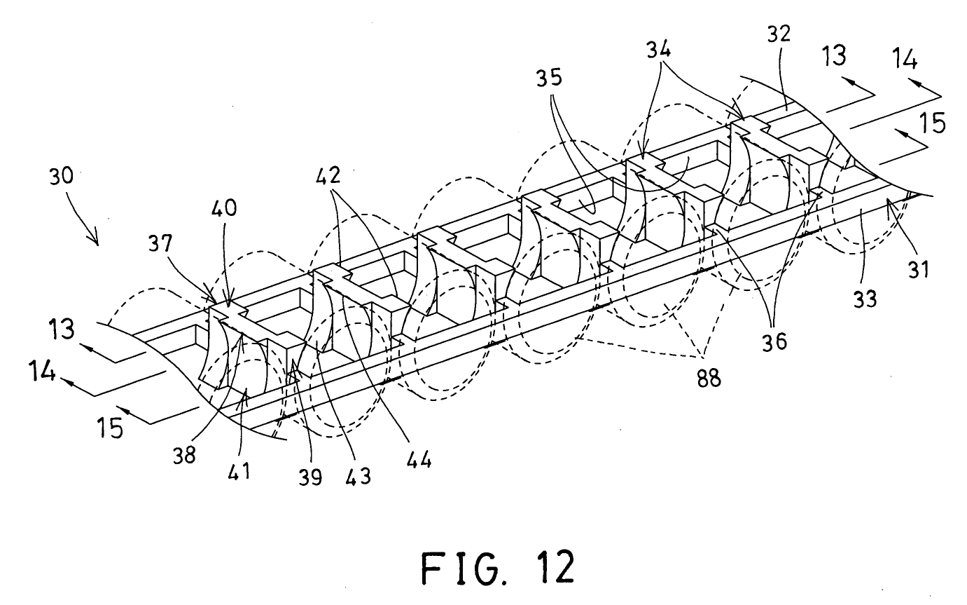

Alternatively, as shown in FIGS. 12-18, another roller holder 30 is disclosed and comprises an outer holding device 31 including one or more, such as two longitudinal and flexible cables or rods 32, 33 disposed or arranged parallel to each other, and arranged in such as two side portions, and a number of spacers 34 disposed between the rods 32, 33 and equally spaced from each other for forming a number of chambers 35 between the rods 32, 33 and the spacers 34 and for snugly engaging with and for retaining a number of balls or rollers or bearing members 88 between the rods 32, 33 and the spacers 34 (FIGS. 12-15), and for preventing the bearing members 88 from being disengaged from the rods 32, 33 and the spacers 34 of the outer holding device 31.

It is preferable that each of the spacers 34 include one or both sides coupled to the rods 32, 33 with a coupler 36, and include a height greater than that of the couplers 36 for resiliently or flexibly coupling the spacers 34 between the rods 32, 33, the couplers 36 may include a height smaller or greater than or equals to that of the rods 32, 33. Each of the spacers 34 include two or more retainers 37, 38, 39 disposed side by side and disposed between the rods 32, 33 and/or the couplers 36. The bearing members 88 are extended out of the spacers 34 of the outer holding device 31 for engaging between the two moving members 80, 81, and for facilitating the sliding movement between the two moving members 80, 81 that will be moved or slid relative to each other.

Each of the retainers 37, 38, 39 of the spacers 34 include an upper portion 40 located or extended upwardly beyond the rods 32, 33 and/or the couplers 36, and a lower portion 41 located or extended downwardly beyond the rods 32, 33 and/or the couplers 36. The retainers 37, 39 each include a protrusion 42, such as curved or cylindrical protrusion 42 extended from one side of the upper portion 40 thereof and another protrusion 43, such as curved or cylindrical protrusion 43 extended from the other or the opposite side of the lower portion 41 thereof for engaging with the bearing members 88, and the other retainers 38 each include a protrusion 44, such as a curved or cylindrical protrusion 44 extended from one side of the upper portion 40 thereof and another protrusion 45, such as curved or cylindrical protrusion 45 extended from the other or the opposite side of the lower portion 41 thereof for engaging with the bearing members 88.

It is preferable that the protrusions 42, 44 of the retainers 37, 38, 39 of the spacers 34 are oppositely extended from the upper portion 40 thereof, and the other protrusions 43, 45 of the retainers 37, 38, 39 of the spacers 34 are oppositely extended from the lower portion 40 thereof for suitably engaging with the bearing members 88 and thus for stably retaining the bearing members 88 between the rods 32, 33 and the spacers 34, and for preventing the bearing members 88 from being disengaged from the rods 32, 33 and the spacers 34 of the outer holding device 31. It is further preferable that the protrusions 42-45 of the spacers 34 at one side of each of the bearing members 88 include one protrusion 42, 44 located above the outer holding device 11, and the other protrusion 43, 45 located below the outer holding device 11.

Further alternatively, as shown in FIGS. 19-24, a further roller holder 50 is disclosed and comprises an outer holding device 51 including one or more, such as two longitudinal and flexible cables or rods 52, 53 disposed or arranged parallel to each other, and arranged in such as two side portions, and a number of spacers 54 disposed between the rods 52, 53 and equally spaced from each other for forming a number of chambers 55 between the rods 52, 53 and the spacers 54 and for snugly engaging with and for retaining a number of balls or rollers or bearing members 88 between the rods 52, 53 and the spacers 54, and for preventing the bearing members 88 from being disengaged from the rods 52, 53 and the spacers 54 of the outer holding device 51.

It is preferable that each of the spacers 54 include one or both sides coupled to the rods 52, 53 with a coupler 56, and include a height greater than that of the couplers 56 for resiliently or flexibly coupling the spacers 54 between the rods 52, 53, the couplers 56 may include a height smaller or greater than or equals to that of the rods 52, 53. Each of the spacers 54 include two or more retainers 57, 58 disposed side by side and disposed between the rods 52, 53 and/or the couplers 56. The bearing members 88 are extended out of the spacers 54 of the outer holding device 51 for engaging between the two moving members 80, 81, and for facilitating the sliding movement between the two moving members 80, 81 that will be moved or slid relative to each other.

Each of the retainers 57, 58 of the spacers 54 include an upper portion 60 located or extended upwardly beyond the rods 52, 53 and/or the couplers 56, and a lower portion 61 located or extended downwardly beyond the rods 52, 53 and/or the couplers 56. The retainers 57 each include two protrusions 62, 63, such as curved or cylindrical protrusions 62, 63 oppositely extended from both sides of the upper portion 60 thereof for engaging with the bearing members 88, and the other retainers 58 each include two protrusions 64, 65, such as curved or cylindrical protrusions 64, 65 oppositely extended from both sides of the lower portion 61 thereof for engaging with the bearing members 88 and for stably retaining the bearing members 88 between the rods 52, 53 and the spacers 54, and for preventing the bearing members 88 from being disengaged from the rods 52, 53 and the spacers 54 of the outer holding device 51.

The typical screw shaft devices or linear motion guide devices fail to provide a number of rollers or bearing members 88 retained between one or more rods 12, 13; 32, 33; 52, 53 and the spacers 14, 34, 54 by the protrusions 22-25; 42-45; 62-65 of the retainers 17-19; 37-39; 57-59 of the spacers 14, 34, 54. The retainers 17-19; 37-39; 57-59 each include two protrusions 22-25; 42-45; 62-65 extended from either or both of the upper portion 20, 40, 60 and the lower portion 21, 41, 61 thereof for suitably engaging with the bearing members 88, and for suitably reducing the contact area between the bearing members 88 and the protrusions 22-25; 42-45; 62-65 of the retainers 17-19; 37-39; 57-59 of the spacers 14, 34, 54.

Accordingly, the roller holder includes a number of rollers or bearing members rotatably retained between spacers for engaging between two moving members and for decreasing the contact area between the rollers and the spacers and for facilitating the sliding movement between the two moving members.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A roller holder for engaging between two moving members, said roller holder comprising:
an outer holding device including a first rod,
a plurality of spacers disposed in said outer holding device and coupled to said first rod and spaced from each other, said spacers each including an upper portion located above said outer holding device, and a lower portion located below said outer holding device, and said spacers each including a first retainer and at least one second retainer disposed side by side, and
a plurality of bearing members disposed in said outer holding device and retained between said first rod and said spacers, and
said spacers each including at least two protrusions extended from each of said first and said at least one second retainers for engaging with said bearing members and for decreasing a contact area between said bearing members and said spacers.

2. The roller holder as claimed in claim 1, wherein said outer holding device includes a second rod coupled to said spacers, said first and said second rods are parallel to each other and said spacers are disposed between said first and said second rods.

3. The roller holder as claimed in claim 1, wherein said outer holding device includes at least one coupler for coupling each of said spacers to said first rod.

4. The roller holder as claimed in claim 1, wherein said at least two protrusions are cylindrical protrusions.

5. The roller holder as claimed in claim 1, wherein said at least two protrusions of said first retainer are oppositely extended from said upper portion of said spacers.

6. The roller holder as claimed in claim 1, wherein said at least two protrusions of said at least one second retainer are oppositely extended from said lower portion of said spacers.

7. The roller holder as claimed in claim 1, wherein one of said at least two protrusions of said first retainer is extended from said lower portion of said spacers and the other of said at least two protrusions of said first retainer is extended from said upper portion of said spacers.

8. The roller holder as claimed in claim 1, wherein one of said at least two protrusions of said at least one second retainer is extended from said lower portion of said spacers and the other of said at least two protrusions of said at least one second retainer is extended from said upper portion of said spacers.

9. The roller holder as claimed in claim 1, wherein said upper portions and said lower portions of said first and said at least one second retainers where no protrusions extended therefrom include an included angle of no less than 90 degrees with said outer holding device.

10. The roller holder as claimed in claim 1, wherein said bearing members are rollers.

11. The roller holder as claimed in claim 1, wherein said at least two protrusions of said spacers at one side of each of said bearing members include one protrusion located above said outer holding device, and the other protrusion located below said outer holding device.
